(19) United States
(12) Patent Application Publication
(10) Pub. No.: US 2005/0096571 A1
(43) Pub. Date: May 5, 2005

(54) Massaging machine and mechanism for adjusting protrusion of massaging balls therefor

(75) Inventor: Akitoshi Miki, Ibaraki (JP)

Correspondence Address: BEYER WEAVER & THOMAS LLP, P.O. BOX 70250, OAKLAND, CA, 94612-0250, US

(73) Assignee: OMRON Healthcare Co., Ltd.

(21) Appl. No.: 10/982,124

(22) Filed: Nov. 4, 2004

(30) Foreign Application Priority Data
Nov. 5, 2003 (JP) 2003-375803

(51) Int. Cl. A61H 15/00

(52) U.S. Cl. 601/99; 601/100; 601/102

(57) ABSTRACT

A massaging machine includes a mechanism for oscillating its massaging unit and adjusting the protrusion of its massaging balls. The mechanism includes a bracket that supports the massaging unit, a supporting device by which the bracket supports the massaging unit by allowing the massaging unit to oscillate with respect to the bracket around a support axis parallel to the crank shaft of the massaging unit, a guiding member and a rotary driver such as a motor that drives the crank shaft rotationally. The guiding member has an elongated opening and a crank pin that engages in the elongated opening and serves to guide the crank pin to move with respect to the bracket perpendicularly to the direction of oscillation of the massaging unit and to the support axis. The massaging machine also includes a bracket guide for guiding movement of the bracket, a bracket driver for moving the bracket along the bracket guide and an oscillation detector for detecting oscillation condition of the massaging unit with respect to the bracket.

Priority is claimed on Japanese Patent Application 2003-375803 filed Nov. 5, 2003.

### BACKGROUND OF THE INVENTION

This invention relates to a massaging machine and more particularly to the mechanism for adjusting the protrusion of its massaging balls.

For adjusting the amount of protrusion by the massaging balls of a massaging machine, Japanese Patent Publication Tokkai 62-197056 disclosed a method by rotating the massaging arm around the massaging shaft, Japanese Patent Publication Tokkai 2002-159549 disclosed a method of rotating the massaging decelerator around a rotary lifting shaft and Japanese Patent Publication Tokkai 2001-149434 disclosed a method of tilting the massaging unit as a whole by rotating the crank shaft of a guide roller.

The structure becomes complicated if the massaging arm is made rotatable around the massaging shaft in order to control the protrusion of the massaging balls, however, and such a method is not practical for a continuous operation. If the massaging decelerator is rotated around the rotary lifting shaft, on the other hand, the massaging machine becomes noisy because a rack-pinion mechanism is used for the deceleration mechanism and is complicated. If the whole of the massaging unit is to be tilted by rotating the crank shaft of a guide roller, furthermore, the massaging unit will be undergoing an oscillating motion and a fairly large space will be required for its motion. This will make it necessary to make the back portion of the chair to be much thicker.

### SUMMARY OF THE INVENTION

It is therefore an object of this invention to provide a compact mechanism of a simple structure for controlling the amount of protrusion of the massaging balls of a massaging machine which will be convenient for a continuous operation.

A mechanism embodying this invention for oscillating a massaging unit of a massaging machine and adjusting protrusion of its massaging balls may be characterized as comprising a bracket that supports the massaging unit, a supporting device by which the bracket supports the massaging unit by allowing the massaging unit to oscillate with respect to the bracket around a support axis parallel to the crank shaft of the massaging unit, a rotary driver such as a motor that drives the crank shaft rotationally, and a guiding member having an elongated opening and a crank pin that engages in the elongated opening and serving to guide the crank pin to move with respect to the bracket perpendicularly to the direction of oscillation of the massaging unit and to the support axis.

With the mechanism thus structured, the protrusion of the massaging balls can be adjusted merely by oscillating the massaging unit around its axis of oscillation from the position where it is contained in the bracket. Thus, the adjustment can be effected with a simple structure without requiring a bulky mechanism. Since the oscillation of the massaging unit can be effected by rotating the crank shaft, a continuous operation is also possible.

In the above, it is preferable to dispose the center axis of oscillation at a lower part of the bracket because the massaging unit becomes tilted in the forward direction as it oscillates and if the massaging balls are disposed at an upper part of the mechanism, it becomes possible to carry out a massaging operation on the shoulders from an upper direction.

It is preferable to form the rotary driver so as to include a drive shaft, a worm gear and a worm wheel that engages the worm gear such that the worm gear and the worm wheel serve to transmit the rotary motion of the drive shaft because a reaction force from the user onto the massaging balls does not adversely affect the oscillation of the massaging balls and hence there is no need to provide any brake.

It is also preferable to provide a box, or cases, for containing the crank shaft, the rotary driver and a power transmission mechanism for transmitting the driving force from a power source for causing the massaging balls to undergo massaging and/or pounding operation.

It is further preferable to provide an oscillation detector for detecting oscillation condition of the massaging unit with respect to the bracket such that the amount of protrusion can be controlled on the basis of the detected condition of oscillation.

A massaging machine embodying this invention may be characterized as comprising such a mechanism as described above, a bracket guide for guiding movement of the bracket and a bracket driver for moving the bracket along the bracket guide.

### BRIEF DESCRIPTION OF THE DRAWINGS

FIG. 1 is a diagonal view taken from the front right-hand side of a massaging machine embodying this invention.

FIG. 2 is a front view of the massaging machine of FIG. 1.

FIG. 3 is a bottom view of the massaging machine of FIG. 1.

FIG. 4A is a back view of the massaging machine of FIG. 1 and FIG. 4B is its sectional view taken along line 4B-4B of FIG. 4A.

FIG. 5 is a right-hand side view of the massaging machine of FIG. 1.

FIG. 6 is a left-hand side view of the massaging machine of FIG. 1.

FIG. 7A is a diagonal right-hand side view of the massaging unit of the massaging machine of FIG. 1 and FIG. 7B is its diagonal left-hand side view.

FIG. 8A is a left-hand side view of the massaging unit of FIGS. 7A and 7B, and FIG. 8B is its sectional view taken along line 8B-8B of FIG. 8A.

FIG. 9 is a back view of the massaging unit.

FIG. 10A is a diagonal right-hand back view of the massaging unit and FIG. 10B is its diagonal left-hand back view.

FIG. 11 A is a diagonal right-hand back view of the massaging unit and FIG. 11B is its diagonal left-hand back view to show its internal structure.

FIGS. 12A, 12B, 12C, 12D and 12E (together referred to as FIG. 12) are drawings for explaining the operation of the strength-adjusting device of the massaging machine embodying this invention.

FIG. 13 is a schematic drawing of the massaging machine of this invention applied to a massaging chair.

FIG. 14A is a right-hand side view of the massaging unit and FIG. 14B is its sectional view taken along line 14B-14B of FIG. 14A.

### DETAILED DESCRIPTION OF THE INVENTION

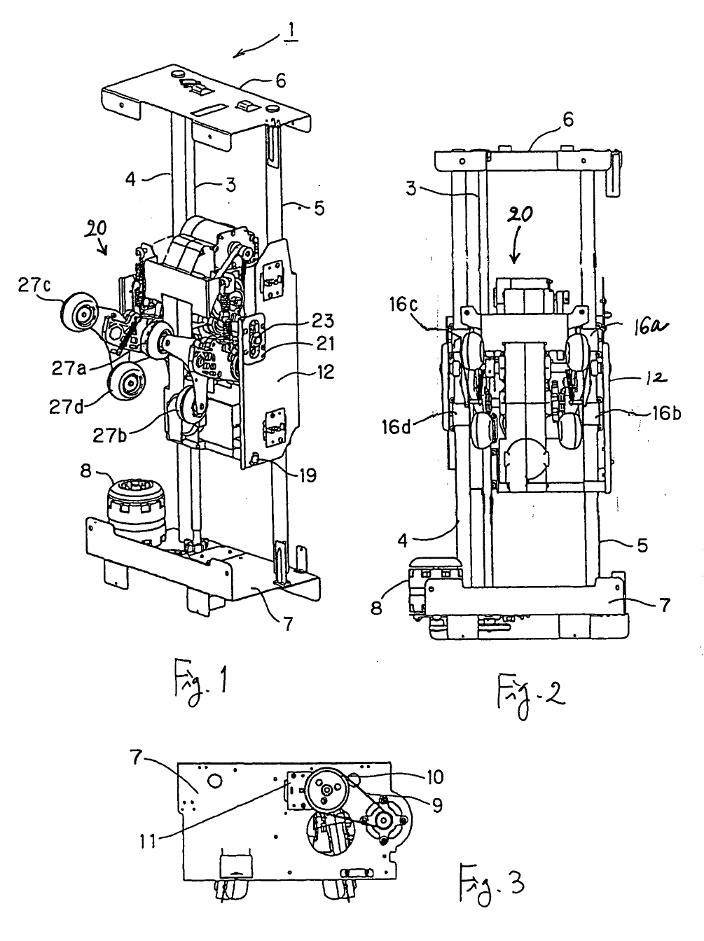

The invention is described next by way of an example with reference to the drawings. FIGS. 1 and 2 are referenced first to explain the structure of a massaging machine 1 embodying this invention, having a massaging unit 20 supported by a screw bar 3 through a bracket 12 for moving vertically and guide pipes 4 and 5 disposed mutually parallel and supported by supporting plates 6 and 7 at their top end parts and bottom parts. The screw bar 3 is positioned so as to be sandwiched between the pair of guide pipes 4 and 5.

FIG. 3 is a bottom view of the massaging machine 1 as seen from below the bottom supporting plate 7 which supports thereon a lifting motor 8. A transmission belt 9 adapted to be rotated by the output shaft of the lifting motor 8 is engagingly wound over a pulley 10 affixed to the bottom end part of the screw bar 3 such that the screw bar 3 will be rotated by the rotary motion of the lifting motor 8. A rotation sensor 11 is also provided to the supporting plate 7 for detecting the rotary angle (rotational position) of the screw bar 3 and the vertical position of the massaging unit 20 therefrom.

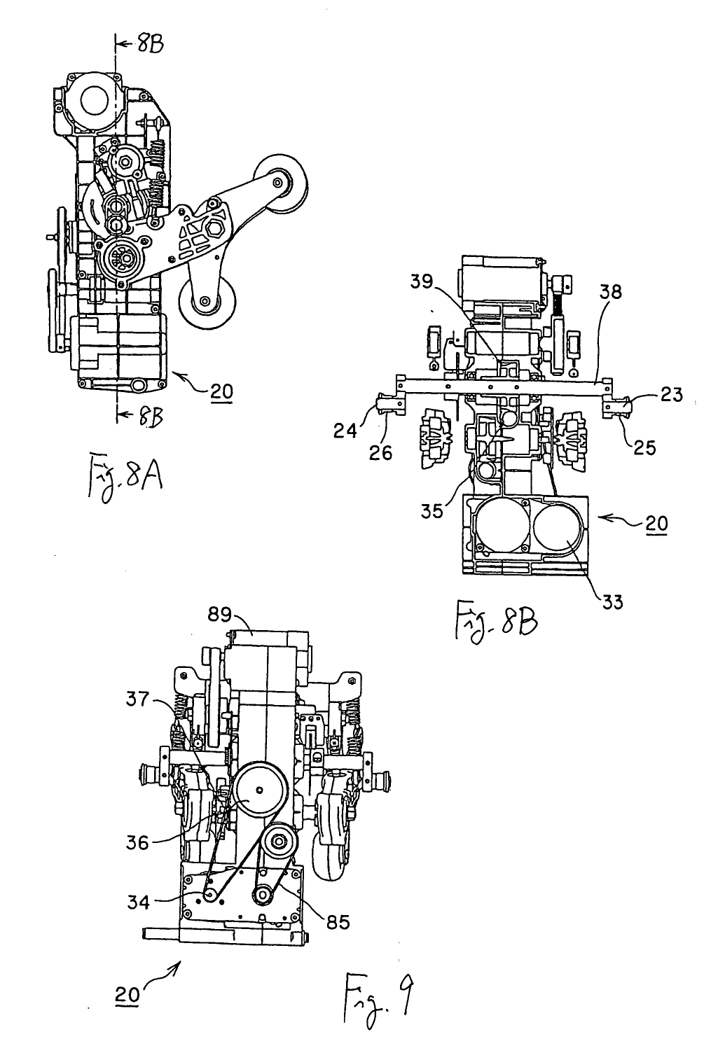

FIG. 4A is a back view of the massaging machine 1 and FIG. 4B is its sectional view taken along line 4B-4B of FIG. 4A. As will be described below more in detail with reference to FIGS. 7 and 8, the massaging unit 20 is supported by the bracket 12 covering both its sides as well as its backside so as to oscillate with respect thereto. The massaging unit 20 supports rotatably four massaging balls 27a, 27b, 27c and 27d (indicated together by numeral 27) arranged in two rows and two columns each at a tip of a pair of approximately V-shaped ball-supporting arms 28 and 29 such that these massaging balls 27 can be driven to move along specified tracks by means of a massaging mechanism and a pounding mechanism to be described below for carrying out a desired kind of therapy. Throughout herein, the direction in which the massaging balls 27 are protruding is referred to as the front, the opposite direction is referred to as the back and the right-hand and left-hand directions are defined according to the positions where the massaging balls 27 are set.

A nut holder 14 is attached to a backside bracket 121, supporting a nut 15 which engages the screw bar 3. As the screw bar 3 is rotated by the lifting motor 8, the nut 15 moves up or down, depending on the direction of this rotation, together with the massaging unit 20 and the bracket 12. Four (two upper and two lower) guide rails 16 (=16a, 16b, 16c and 16d) are attached to the bracket 12 for guiding the bracket 12 in its vertical movement along the guide pipes 4 and 5, two of these four guide rails 16 corresponding to each of the guide pipes 4 and 5.

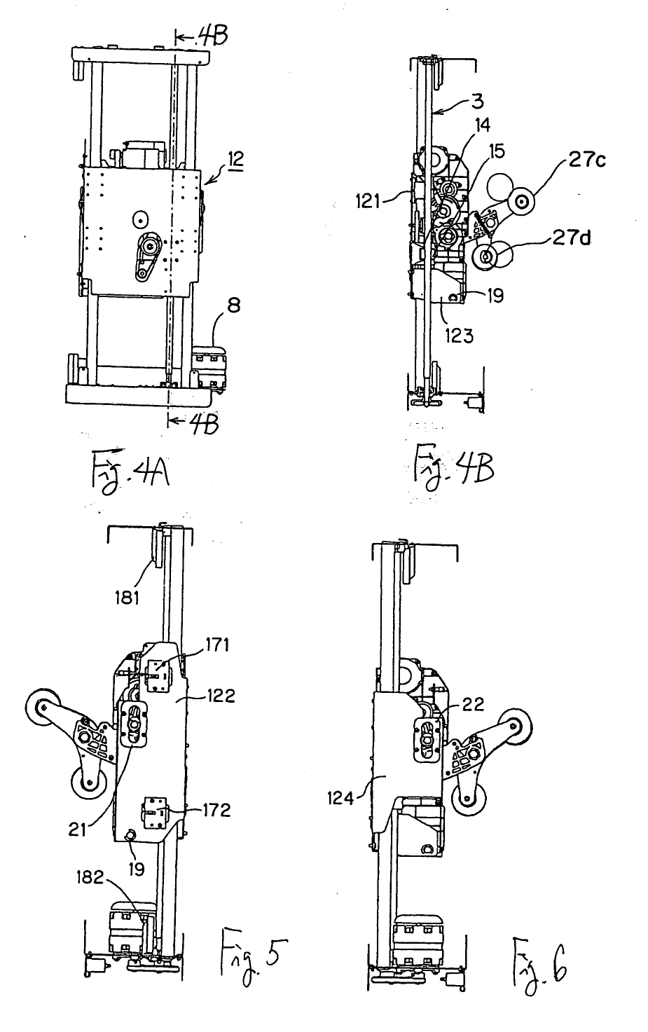

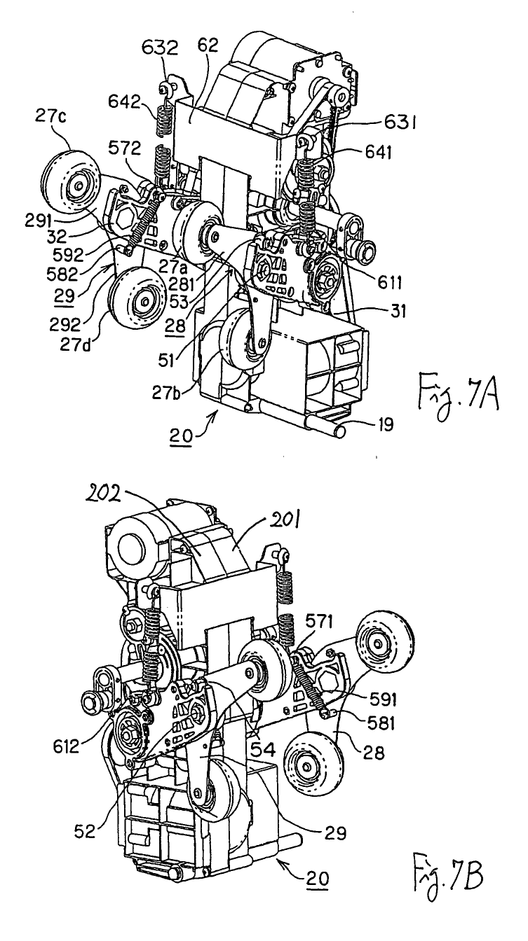

FIG. 5 shows the massaging machine 1 from the right-hand side. As shown, two limit sensors 171 and 172 are attached to a right-hand bracket 122 and sensor dogs 181 and 182 are set respectively on the top and bottom supporting plates 6 and 7 at positions corresponding to these limit sensors 171 and 172. As the massaging unit 20 is moved upward along the guide pipes 4 and 5, the detection of the upper sensor dog 181 by the upper limit sensor 171 signals the upper limit of the vertical motion of the massaging unit 20. As the massaging unit 20 is moved downward along the guide pipes 4 and 5, the detection of the lower sensor dog 182 by the lower limit sensor 172 signals the lower limit of the vertical motion of the massaging unit 20. Aforementioned guide pipes 4 and 5 and guide rails 16 are together referred to as the “bracket guiding device” and aforementioned lifting motor 8, motion-transmitting belt 9, pulley 10, screw bar 3 and nut 15 are together referred to as the “bracket driving device”.

The four massaging balls 27 of the massaging unit 20, the massaging mechanism and the pounding mechanism for driving them are disposed between the screw bar 3 and the right-hand guide pipe 5. The screw bar 3 is situated closer to the left-hand guide pipe 4 than to the right-hand guide pipe 5.

A planar shaft-supporting bracket 123 for supporting the rotary shaft 19 of a strength-adjusting mechanism, to be described below, is attached to the backside bracket 121 at a position between the screw bar 3 and the massaging unit 20. The other end part (on the right-hand side) of this rotary shaft 19 is supported by the right-hand bracket 122.

FIG. 6 shows the left-hand side of the massaging machine 1 with its left-hand bracket 124. Guide rails 21 and 22 for the strength-adjusting mechanism are attached respectively to the right-hand bracket 122 and the left-hand bracket 124. These guide rails 21 and 22 are each provided with a vertically elongated opening into which rollers 25 and 26 attached to strength-adjusting arms 23 and 24, to be described below, are engagingly inserted.

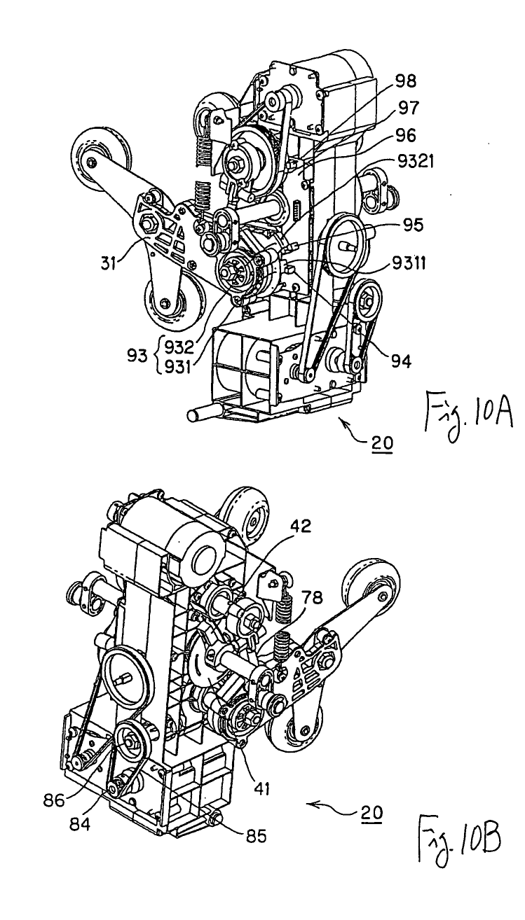

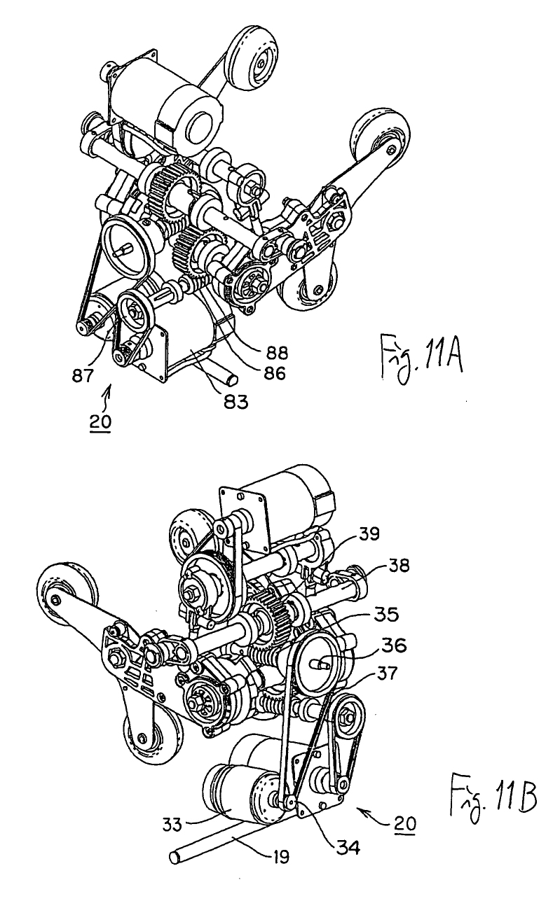

As shown in FIGS. 7-11 and as already explained above, the massaging unit 20 supports rotatably the four massaging balls 27 arranged in two rows and two columns each at a tip of the approximately V-shaped ball-supporting arms 28 and 29. The ball-supporting arms 28 and 29 are rotatably supported by arm-supporting members 31 and 32. The massaging machine 1 is adapted to move these arm-supporting members along specified tracks such that specified massaging and pounding operations are carried out by the massaging balls 27.

A strength-adjusting motor 33 is contained in the front-back direction below and on the right-hand side of cases 201 and 202 (together also referred to as a “box”). The output shaft of the strength-adjusting motor 33 protrudes backward from the massaging unit 20, having a pulley 34 attached to its outer periphery. A worm gear 35 for strength adjustment is disposed in the front-back direction approximately at the center between the cases 201 and 202, having a pulley 36 attached coaxially therewith at its backward end part. An endless transmission belt 37 is wound over these two pulleys 34 and 36 such that the driving power of the strength-adjusting motor 33 is transmitted to the worm gear 35 through the transmission belt 37. A transversely extending strength-adjusting shaft 38 is passed through the center of the cases 201 and 202, having a worm wheel 39 attached to its outer periphery approximately at its center in its axial direction. The worm wheel 39 engages with the worm gear 35 such that the rotary driving power of the strength-adjusting motor 33 is transmitted to the worm wheel 39 through the worm gear 35, causing the coaxial strength-adjusting shaft 38 to rotate.

It is advantageous to use the worm gear 35 and the worm wheel 39 as explained above for the transmission of power from the strength-adjusting motor 33 because the reaction force from the user onto the massaging balls 27 hardly affects the oscillatory motion of the massaging unit 20 and hence no brake is required for limiting the reverse motion of the massaging unit 20.

On both right-hand and left-hand end parts of the strength-adjusting shaft 38, strength-adjusting arms 23 and 24, extending parallel thereto, are attached eccentrically thereto in the same direction. Arm rollers 25 and 26 are attached to the outer peripheries of the strength-adjusting arms 23 and 24, respectively.

In what follows, the strength-adjusting shaft 38 is also referred to as a crank shaft, and the strength-adjusting arms 23 and 24 are also referred to as crank pins. The strength-adjusting motor 33, the pulleys 34 and 36, the worm gear 35, the transmission belt 37 and the worm wheel 39 are together referred to as forming a rotary driver. Since the crank shaft and the rotary driver for adjusting the strength of massaging operation, as well as the source of driving power and the power transmission mechanism for the massaging operation can be contained compactly, the massaging unit 20 as a whole can be made smaller and the number of constituent parts and the production cost can be reduced.

The arm rollers 25 and 26 on the strength-adjusting arms 23 and 24 engage with the guide rails 21 and 22 serving as guiding members so as to move therealong as the strength-adjusting shaft 38 is rotated and to thereby change the positional relationship between the strength-adjusting shaft 38 and the guide rails 21 and 22.

The strength-adjusting shaft 38 is supported by the cases 201 and 202 of the massaging unit 20, and the aforementioned rotary shaft 19 passes rotatably in the transverse direction at the bottom end of the cases 201 and 202. The end parts of this rotary shaft 19 are supported by the shaft-supporting bracket 123 and the right-hand bracket 122.

As explained above, the positional relationship between the strength-adjusting shaft 38 and the guide rails 21 and 22 changes as the strength-adjusting shaft 38 rotates. At the same time, the positional relationship also changes between the massaging unit 20 to which the strength-adjusting shaft 38 is attached and the bracket 12 to which the guide rails 21 and 22 are attached. Since the massaging unit 20 is supported through the rotary shaft 19 so as to freely oscillate with respect to the bracket 12, the massaging unit 20 oscillates with respect to the bracket 12 as the strength-adjusting shaft 38 is rotated.

The vertical length of the elongated openings provided to the guide rails 21 and 22 is selected to be longer than the diameter of the circular track of the arm rollers 25 and 26 around the strength-adjusting shaft 38 such that the rotary motion of the arm rollers 25 and 26 at the top and bottom ends of the elongated openings in the guide rails 21 and 22 need not be reversed and hence that the direction of rotation of the strength-adjusting motor 33 need not be reversed. This serves to improve the useful lifetime of the motor. Alternatively, it may be so arranged that the direction of rotation of the strength-adjusting motor 33 is reversed by using the result of detection by a rotation sensor 42 to be described below.

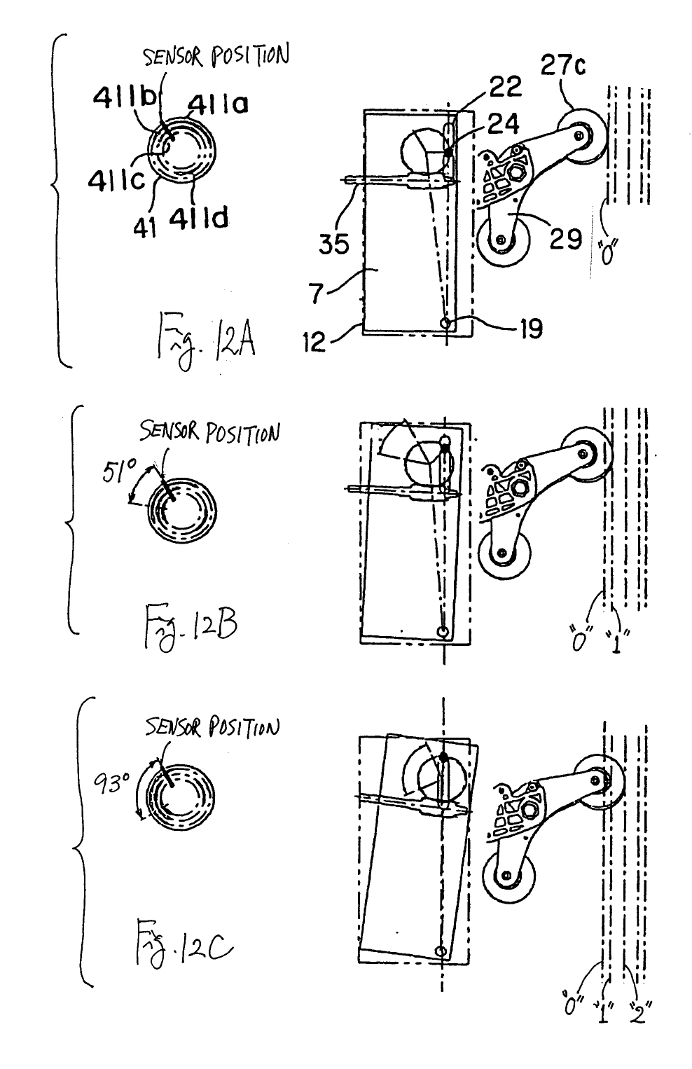

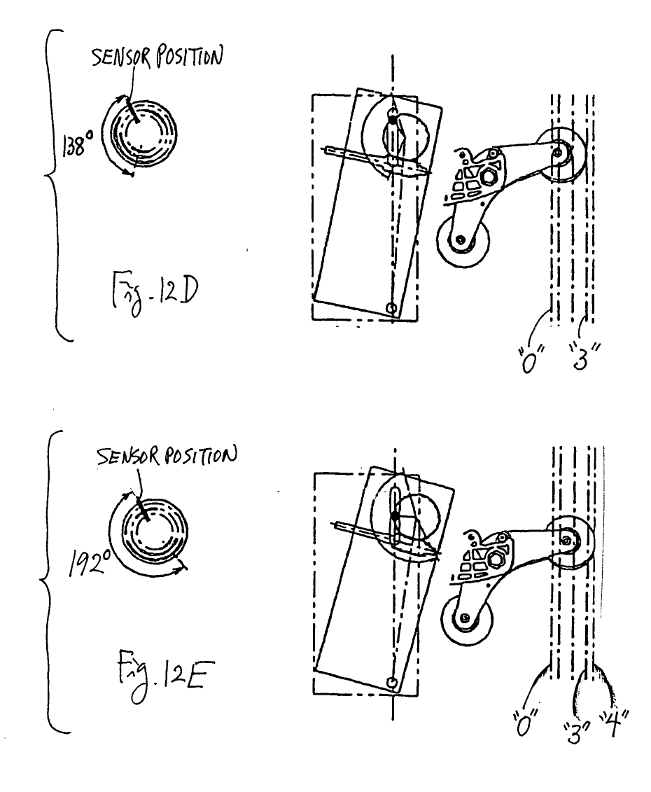

A disc-shaped sensor dog 41 is disposed on the outer periphery of the strength-adjusting shaft 38 at a position on the left-hand side of the massaging unit 20. This sensor dog 41 is provided with circumferentially elongated openings 411a, 411b, 411c and 411d at different radial positions and having different lengths or positions, as shown in FIG. 12. The aforementioned rotation sensor 42 is attached to the left-hand side surface of the massaging unit 20 and is disposed so as to cover both surfaces of the sensor dog 41 from the outer peripheral direction. The rotation sensor 42 is provided with a light-emitting element and a light-receiving element and has optical paths passing through radially different positions corresponding to the openings. It is adapted to detect the interruption of these optical paths by the sensor dog 41 and to thereby detect the angular position of the strength-adjusting shaft 38.

In the above, the sensor dog 41 and the rotation sensor 42 are also together referred to as an oscillation detector.

FIG. 12A shows a moment at which the reference position (origin) of the sensor dog 41 is being detected by the rotation sensor 42. The rotation sensor 42 measures angles in the counter-clockwise direction (as seen on the figure) from this reference position. The rotation sensor 42 is shown as detecting three openings 411a, 411b and 411c of the sensor dog 41. At this moment, the strength-adjusting arms 23 and 24 are in front of the strength-adjusting shaft 38 and at a position nearly at the center of the elongated openings of the guide rails 21 and 22. The massaging unit 20 is not tilted but is parallel to the bracket 12. The horizontal position of the front end of the upper massaging balls 27a and 27c at this moment is indicated by numeral “0”.

FIG. 12B shows the moment at which the strength-adjusting shaft 38 and the sensor dog 41 have been rotated by 51° in the counter-clockwise direction from the origin. The rotation sensor 42 is now detecting two of the openings 411a and 411b of the sensor dog 41. At this moment, the strength-adjusting arms 23 and 24 are diagonally upward in front of the strength-adjusting shaft 38 and at an upward position in the elongated openings of the guide rails 21 and 22. The massaging unit 20 is somewhat tilted in the forward direction with respect to the bracket 12 around the rotary shaft 19. The horizontal position of the front end of the upper massaging balls 27a and 27c at this moment is indicated by numeral “1” and is forwardly displaced from the position “0”.

FIG. 12C shows the moment at which the strength-adjusting shaft 38 and the sensor dog 41 have been rotated by 93° in the counter-clockwise direction from the origin. The rotation sensor 42 is now detecting only one of the openings 411a of the sensor dog 41. At this moment, the strength-adjusting arms 23 and 24 are directly above the strength-adjusting shaft 38 and at the top position in the elongated openings of the guide rails 21 and 22. The massaging unit 20 is further forwardly tilted with respect to the bracket 12 around the rotary shaft 19. The horizontal position of the front end of the upper massaging balls 27a and 27c at this moment is indicated by numeral “2” and is further forwardly displaced from the position “1”.

FIG. 12D shows the moment at which the strength-adjusting shaft 38 and the sensor dog 41 have been rotated by 138° in the counter-clockwise direction from the origin. The rotation sensor 42 is now detecting none of the openings 411a, 411b and 411c of the sensor dog 41. At this moment, the strength-adjusting arms 23 and 24 are diagonally above and behind the strength-adjusting shaft 38 and at an upwardly position in the elongated openings of the guide rails 21 and 22. The massaging unit 20 is still further forwardly tilted with respect to the bracket 12 around the rotary shaft 19. The horizontal position of the front end of the upper massaging balls 27a and 27c at this moment is indicated by numeral “3” and is still further forwardly displaced from the position “2”.

FIG. 12E shows the moment at which the strength-adjusting shaft 38 and the sensor dog 41 have been rotated by 192° in the counter-clockwise direction from the origin. The rotation sensor 42 is now detecting the opening 411d of the sensor dog 41. At this moment, the strength-adjusting arms 23 and 24 are behind the strength-adjusting shaft 38 and at a position nearly at the center of the elongated openings of the guide rails 21 and 22. The massaging unit 20 is even further forwardly tilted with respect to the bracket 12 around the rotary shaft 19. The horizontal position of the front end of the upper massaging balls 27a and 27c at this moment is indicated by numeral “4” and is even further forwardly displaced from the position “3”.

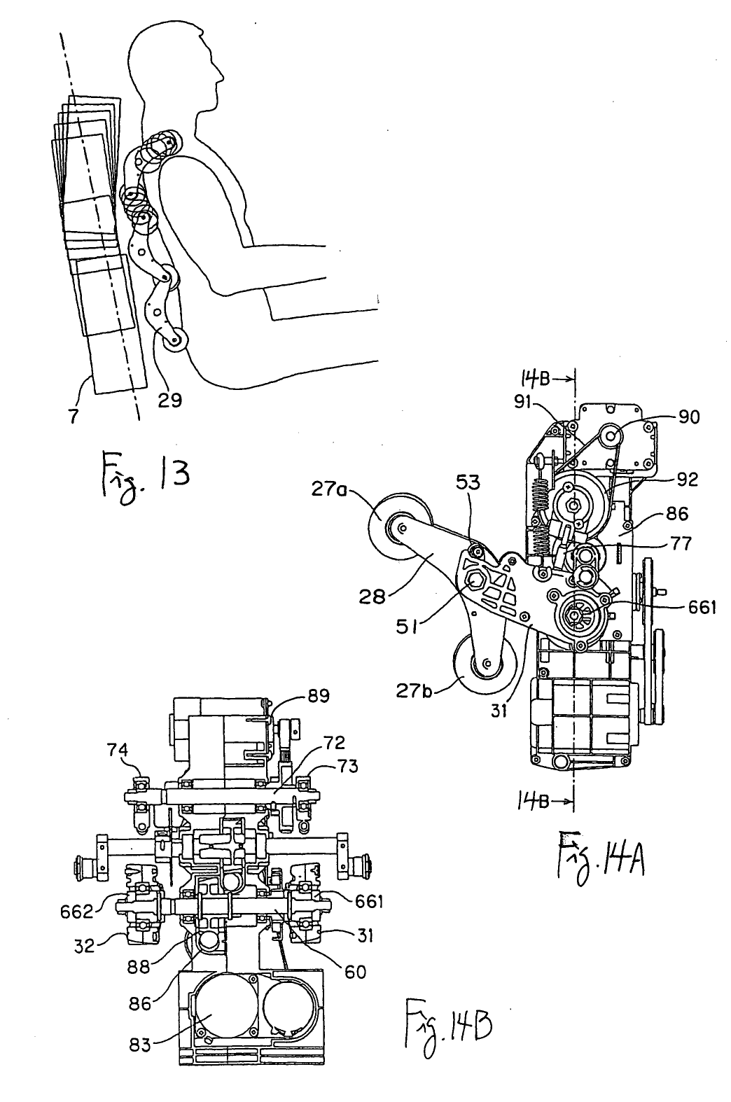

The strength-adjusting operation is explained next by way of an example where the massaging unit 1 of this invention is incorporated in the back portion of a massaging chair. FIG. 13 shows the changes in the orientation and position of the massaging balls 27 as the massaging unit 20 is raised along the guide pipes 4 and 5 of which the orientation is indicated by a dashed line.

When the massaging unit 20 is at the height of the user's waste, the massaging unit 20 is oriented parallel to the guide pipes 4 and 5, as shown in FIG. 12A. At this moment, the ball-supporting arms are oriented as shown due to the force from the user such that both the upper and lower massaging balls contact the user's back to carry out the therapy. As the massaging unit 20 moves upward, it begins to tilt forward with respect to the guide pipes 4 and 5. When the massaging unit 20 reaches the height of the user's shoulders, the strength-adjusting shaft 38 may be rotated, for example, into the position of FIG. 12E such that the upper massaging balls protrude forward and come to upper positions of the shoulders and the lower massaging balls come to positions behind the shoulders. In other words, therapy can be effected not only behind the shoulders but also on the upper parts of the shoulders.

It is also possible to change the angular position of the strength-adjusting shaft 38 when the massaging unit 20 is at any position with respect to the guide pipes 4 and 5 so as to adjust the protruding positions of the upper massaging balls and to thereby change the compressive force on the contacting body part of the user.

According to still another method of operation, the strength-adjusting shaft 38 is rotated in the same direction when the massaging unit 20 is at an arbitrary position with respect to the guide pipes 4 and 5 or while it is being moved such that the distance of protrusion by the massaging balls 27 will continuously change and hence that an effect of shiatsu massage can be obtained. Since the strength-adjusting shaft 38 is in the form of a crank, a sinusoidal motion can be obtained by its rotational motion. In other words, the motion of oscillation is the slowest when the massaging unit 20 is protruding the farthest in the forward direction or is retracted the most in the backward direction. Thus, although the strength-adjusting motor 33 rotates at a constant speed, the feeling of natural shiatsu can be experienced by the user.

In summary, with a strength-adjusting mechanism thus structured, the strength of massaging can be adjusted merely by the oscillating motion of the massaging unit 20 from the condition where it is contained in the bracket 12, that is, without requiring the massaging machine to become large in size. Since the oscillatory motion of the massaging unit 20 is effected by the rotary motion of the strength-adjusting shaft 38, the structure can remain simple and continuous operations are also possible. It is also possible to carry out adjustments at a high speed of operation.

Some other aspects of the structure of the massaging unit 20 are explained next with reference (in part) to FIG. 14A which is its right-hand side view and FIG. 14B which is a sectional view.

As explained above, the massaging unit 20 supports rotatably four massaging balls 27 arranged in two rows and two columns each at a tip of a pair of approximately V-shaped ball-supporting arms 28 and 29 supported rotatably by the arm-supporting members 31 and 32 around rotary shafts 51 and 52, respectively. Each of the ball-supporting arms 28 and 29 is provided with a stopper 53 or 54 for stopping its rotary motion which is limited by the contact between the stopper 53 or 54 with the corresponding arm-supporting member 31 or 32.

Inside the arm-supporting members 31 and 32 and at positions inside the ball-supporting arms 28 and 29 near their base ends, there are inwardly protruding columnar members 571, 572, 581 and 582 connected by coil springs 59. These coil springs 59 serve to provide a biasing force on lower parts 282 and 292 of the ball-supporting arms 28 and 29 in a diagonally backward direction such that the upper massaging balls 27a and 27c will protrude forward and the lower massaging balls 27b and 27d will be retracted backward under normal conditions when there is no external force acting on them.

Outwardly protruding columnar members 611 and 612 are formed on the outer sides of upper parts of the arm-supporting members 31 and 32 in the direction of a massaging shaft 60. A sectionally U-shaped planar member 62 is attached to the front of an upper portion of the massaging unit 20 with its right-hand and left-hand end parts further bent in outward directions. Forwardly protruding columnar members 631 and 632 are formed on these outwardly bent side end parts. Noise-suppressing springs 641 and 642 are stretched between the outwardly protruding columnar members 611 and 612 and the forwardly protruding members 631 and 632 for supplying biasing forces on the arm-supporting members 31 and 32 in upward directions such that their oscillations at the time of the pounding operations of the massaging machine are thereby absorbed and suppressed.

Cylindrical sloped sleeves 661 and 662 are affixed on both sides of the massaging shaft 60, each sloped with respect to its axial direction and eccentric in its radial direction. These sleeves 661 and 662 are sloped symmetrically with respect to each other in the right-left direction. The arm-supporting members 31 and 32 (made of a resin material) are rotatably engaged to the outer peripheral surfaces of the sloped sleeves 661 and 662 through bearings.

As shown in FIG. 14B, there is a pounding shaft 72 disposed above and parallel to the massaging shaft 60. Link-attaching members 73 and 74 are rotatably attached through bearings on both sides of the pounding shaft 72 at positions corresponding to the arm-supporting members 31 and 32. The link-attaching members 73 and 74 and the arm-supporting members 31 and 32 are connected by links 77 and 78. The links 77 and 78 are connected to the pounding shaft 72 so as to be able to oscillate in the axial direction. The ends of the links 77 and 78 on the sides of the arm-supporting members 31 and 32 are spherically shaped and are connected so as to oscillate along their spherical surfaces.

Regarding the massaging mechanism of the massaging unit 20, what is herein referred to as the driving power source for the massaging operation is represented by a massaging motor 83 which is disposed next to the strength-adjusting motor 33 at a lower part of the massaging unit 20, and what is herein referred to as its power transmission mechanism includes the massaging shaft 60, a small pulley 84 attached to the output shaft of the massaging motor 83, a worm wheel 88 attached coaxially to the outer periphery of the massaging shaft 60, a worm gear 86 disposed in the front-back direction on the massaging unit 20 and engaging with the worm wheel 88 a larger pulley 87 attached to the shaft of the worm gear 86 and an endless transmission belt 85 wound over the outer peripheries of the pulleys 84 and 87.

Regarding the pounding mechanism of the massaging unit 20, what is herein referred to as the driving power source for the pounding operation is represented by a pounding motor 89 which is at an upper backward position of the massaging unit 20, and what is herein referred to as its power transmission mechanism includes a pounding shaft 72 which is driven by the pounding motor 89, a small pulley 90 attached to the output shaft of the pounding motor 89, a large pulley 92 attached coaxially to the outer periphery of the pounding shaft, 72 and an endless transmission belt 91 wound over the outer peripheries of the pulleys 90 and 92.

An approximately disc-shaped massaging sensor dog 93 is disposed on the outer periphery of the massaging shaft 60 at a position inside the right-hand arm-supporting member 31. This massaging sensor dog 93 is comprised of a disc-shaped portion 931 of the same diameter and a protrusion 932 which protrudes outward from the disc-shaped portion 931. The peripheral parts of the disc-shaped portion 931 are bent into the axial direction to form a detection target part 9311. The detection target part 9311 may be formed only at one place on the periphery or at a plurality of places. The outer end part of the protrusion 932 is also bent in the axial direction to form an origin detection target part 9321. A rotation sensor 94 and an origin sensor 95 for the massaging shaft 60 respectively corresponding to the detection target part 9311 and the origin detection target part 9321 are disposed on a sensor board 96 opposite the massaging sensor dog 93. The rotation sensor 94 and the origin sensor 95 are each adapted to detect the interruption of the optical path from its light-emitting part and light-receiving part. The sensor board 96 is attached to the right-hand side surface of the massaging unit 20.

A pounding sensor dog 97 is disposed on the outer periphery of the pounding shaft 72 at a position inside the large pulley 92 for the pounding motion. The pounding sensor dog 97 also comprises a disc-shaped material, like the massaging sensor dog 93, with its peripheral part bent in the axial direction to form a detection target part. A rotation sensor 98 corresponding to this pounding sensor dog 97 is also disposed on the same sensor board 96 and is structured similarly to the aforementioned rotation sensor 94 for the massaging shaft 60.

The massaging unit 20 thus structured is adapted to undergo its massaging operation by stopping the rotation of the pounding shaft 72 and by rotating only the massaging shaft 60. At this time, the massaging balls 27 move such that the distance between the left-hand massaging balls 27a and 27c and the right-hand massaging balls 27b and 27d will vary. It is also possible to switch between an upward massaging mode and a downward massaging mode by changing the direction of rotation of the massaging shaft 60.

If the rotation of the massaging shaft 60 is stopped and only the pounding shaft 72 alone is rotated and the ball-supporting arms 28 and 29 are caused to oscillate around the massaging shaft 60, the massaging unit 20 can function in the pounding mode.

If both the massaging shaft 60 and the pounding shaft 72 are stopped and the massaging unit 20 is moved vertically upward and downward along the guide pipes 4 and 5, the massaging unit 20 can be used in a back-stretching mode of operation.

1. A mechanism for oscillating a massaging unit of a massaging machine and adjusting protrusion of massaging balls of said massaging unit, said mechanism comprising:
a bracket that supports said massaging unit;
a supporting device by which said bracket supports said massaging unit by allowing said massaging unit to oscillate with respect to said bracket around a support axis, said massaging unit including a crank shaft disposed parallel to said support axis;
a rotary driver that drives said crank shaft rotationally; and
a guiding member having an elongated opening and a crank pin that engages in said elongated opening and serving to guide said crank pin to move with respect to said bracket perpendicularly to the direction of oscillation of said massaging unit and to said support axis.

2. The mechanism of claim 1 wherein said support axis is at a lower part of said bracket.

3. The mechanism of claim 1 wherein said rotary driver includes a drive shaft, a worm gear and a worm wheel that engages said worm gear, said worm gear and said worm wheel transmitting rotary motion of said drive shaft.

4. The mechanism of claim 1 further comprising a box that contains therein said crank shaft, said rotary driver and a power transmission mechanism that transmits driving force from a power source for causing said massaging balls to undergo at least one selected from the group consisting of massaging operation and pounding operation.

5. The mechanism of claim 1 further comprising an oscillation detector that detects oscillation condition of said massaging unit with respect to said bracket.

6. A massaging machine comprising:
a massaging unit having massaging balls;
an adjustment mechanism for oscillating said massaging unit and adjusting protrusion of said massaging balls, said mechanism including:
a bracket that supports said massaging unit;
a supporting device by which said bracket supports said massaging unit by allowing said massaging unit to oscillate with respect to said bracket around a support axis, said massaging unit including a crank shaft disposed parallel to said support axis;
a rotary driver that drives said crank shaft rotationally; and
a guiding member having an elongated opening and a crank pin that engages in said elongated opening and serving to guide said crank pin to move with respect to said bracket perpendicularly to the direction of oscillation of said massaging unit and to said support axis;
a bracket guide that guides movement of said bracket; and
a bracket driver that moves said bracket along said bracket guide.

7. The massaging machine of claim 6 wherein said support axis is at a lower part of said bracket.

8. The massaging machine of claim 6 wherein said rotary driver includes a drive shaft, a worm gear and a worm wheel that engages said worm gear, said worm gear and said worm wheel transmitting rotary motion of said drive shaft.

9. The massaging machine of claim 6 further comprising a box that contains therein said crank shaft, said rotary driver and a power transmission mechanism that transmits driving force from a power source for causing said massaging balls to undergo at least one selected from the group consisting of massaging operation and pounding operation.

10. The massaging machine of claim 6 further comprising an oscillation detector that detects oscillation condition of said massaging unit with respect to said bracket.
